(19) United States
(12) Patent Application Publication
(10) Pub. No.: US 2004/0230901 A1
(43) Pub. Date: Nov. 18, 2004

(54) Portlet style conformity on pervasive agents

(75) Inventors: James Russell Godwin, Raleigh, NC (US); Michael C. Wanderski, Durham, NC (US)

Correspondence Address: Steven M.Greenberg, Esquire, Akerman, Senterfitt P.A., Post Office Box 3188, West Palm Beach, FL, 33401-3188, US

(73) Assignee: International Business Machines Corporation, Armonk, NY

(21) Appl. No.: 10/439,867

(22) Filed: May 15, 2003

(51) Int. Cl. G06F 15/00

(52) U.S. Cl. 715/513

(57) ABSTRACT

A portal server system and method is provided. The portal server system can include a portal coupled to one or more portlets, each portlet having associated portlet rendering logic. The system also can include a portlet aggregator communicatively linked to the portlet rendering logic. Finally, a visual service extension to the portlet aggregator can be provided. The visual service extension can be programmed to process the portlet rendering logic to transform visual stye attributes in the portlet rendering logic into markup language tags which can be rendered for display in a specified type of pervasive agent. In any event, preferably, the portlet rendering logic can be a Java server page (JSP).

### BACKGROUND OF THE INVENTION

1. Statement of the Technical Field

The present invention relates to the field of portals and portlets and more particularly to the styling of a portal view in the display of a pervasive agent.

2. Description of the Related Art

Distributing content about large computer communications networks is not without its challenges. In particular, the quantity of content available for distribution in a computer communications network often varies proportionally to the size of the computer communications network. At the extreme, the Internet hosts a vast quantity of content not easily accessible by most end-users. Portals represent a sensible solution to the problem of aggregating content through a channel paradigm in a single, network-addressable location. In consequence, portals have become the rage in content distribution.

Portlets are the visible active components included as part of portal pages. Similar to the graphical windows paradigm of windowing operating systems, each portlet in a portal occupies a portion of the portal page through which the portlet can display associated content from a portlet channel. Portlets are known to include both simple applications such as an electronic mail client, and also more complex applications such as forecasting output from a customer relationship management system. The prototypical portlet can be implemented as server-side scripts executed through a portal server.

From the end-user perspective, a portlet is a content channel or application to which the end-user can subscribe. By comparison, from the perspective of the content provider, a portlet is a means through which content can be distributed in a personalized manner to a subscribing end-user. Finally, from the point of view of the portal, a portlet merely is a component which can be rendered within the portal page. In any case, by providing one or more individually selectable and configurable portlets in a portal, portal providers can distribute content and applications through a unified interface in a personalized manner according to the preferences of the end-user.

Traditionally, portals can be accessed through desktop browser applications. Browsers have been referred to as “rich clients” as browsers can provide powerful rendering capabilities, including the ability to apply style sheets to content to ensure conformity in visual appearance between applications. Recently, though, pervasive devices such as handheld computers, cellular phones and the like have begun to substantially penetrate the consumer and enterprise markets. Moreover, pervasive devices have become the user interface of choice. Consequently, portal software will be increasingly targeted for these resource limited devices.

Today, style sheets such as the cascading style sheet (CSS) provide the unifying mechanism for ensuring conformity of coloring and styling schemes across disparate applications for desktop portals. Additionally, by selecting various style sheets, new themes can be applied to the portal interface dynamically. More particularly, new themes can be applied to the portal interface dynamically by defining a “style guideline” where hypertext markup language (HTML) markup tags contained in a portlet view include a class attribute that associates a name with a particular styling scheme.

An example of such a markup tag can include <p class =“myTextStyle”>My Text</p>. Where a style sheet definition of “.myTextStyle {color:#000000; font-weight: bold; font-size: 12pt;}” can be applied at the client, and the text “My Text” can be displayed as a black, bold font with a size of twelve. Still, pervasive devices of limited display resources such as the conventional handheld computer, do not support this style sheet rendering capability. Accordingly, as portals move to support pervasive devices, a methodology to adapt to these restricted styling capabilities is required in order to maintain a consistent visual aggregation across applications as well as support the dynamic ability to conform to various styling themes.

Conventional portlets are configured for use with the Model-View-Controller scheme in which the model can manage the underlying data for the portlet, the view can present the data through an interface, and the controller can manage the use and presentation of the data in the view. To support pervasive devices using Model-View-Controller, a controller would be required to generate a suitable view for each unique type of pervasive device. Still, the generation of multiple controllers for each unique type of device hardly seems scalable. As an alternative, the user-agent of a requesting device can be compared to a list of supported devices. Unique rendering logic such as a Java server page (JSP) can be included for each type of device and the content can be rendered accordingly. Yet, to incorporate multiple sets of rendering logic within the portlet code can be cumbersome and difficult to maintain and upgrade.

### SUMMARY OF THE INVENTION

The present invention is a system, method and apparatus for ensuring portlet style conformity across disparate pervasive agents, including handheld computing devices. In accordance with the present invention, the contents of rendering logic can be intercepted before compilation by the controller, for instance using server page custom tags. The rendering logic can be modified based upon a set of separately specified rules set forth for a specific device. The modified rendering logic subsequently can be submitted to portal aggregation logic for execution. In this way, the specialized and unique viewing requirements of each target pervasive device can be accommodated without requiring manual changes to the rendering logic and without requiring the creation of a new controller for each disparate pervasive device.

A method for rendering a portal view in conformity with a portal style for display in a pervasive agent can include loading a style sheet defining a theme for the portal. Visual rendering attributes for the defined theme can be mapped to markup language tags specific to a specific type of pervasive agent. Portlet rendering logic for a specified portlet can be parsed to identify embedded style attribute references. Selected ones of the embedded style attribute references in the portlet rendering logic can be replaced with mapped ones of the markup language tags. Finally, the portlet rendering logic can be compiled for use in producing a view for the specified portlet.

Notably, in a preferred aspect of the present invention, the portlet rendering logic can be purged of unsupported tags. In this regard, the purging step can include the step of replacing the unsupported tags with supported tags. Alternatively, the purging step can include the step of deleting the unsupported tags. In another preferred aspect of the present invention, the loading step can include identifying one of a user agent for the portlet and a markup language type for the portlet. Subsequently, a style sheet corresponding to the identified one of the user agent and the markup language type can be loaded. Finally, in yet another preferred aspect of the invention, the replacing step further can include the step of replacing selected ones of the style attribute references in the portlet rendering logic with a scriptlet configured to recursively resolve a composite tag from a series of nested style attribute references according to mapped ones of the visual rendering attributes.

A portal server system also can be provided in accordance with the inventive arrangements. The portal server system can include a portal coupled to one or more portlets, each portlet having associated portlet rendering logic. The system also can include a portlet aggregator communicatively linked to the portlet rendering logic. Finally, a visual service extension to the portlet aggregator can be provided. The visual service extension can be programmed to process the portlet rendering logic to transform visual stye attributes in the portlet rendering logic into markup language tags which can be rendered for display in a specified type of pervasive agent. In any event, preferably, the portlet rendering logic can be a JSP.

Finally, a portal server can be provided in accordance with the present invention. The portal server can include a portlet aggregator configured to aggregate portlet views into a single portal view. Additionally, a visual service extension to said portlet aggregator can be provided. The visual service extension can be programmed to process portlet rendering logic, such as a JSP, for selected ones of the portlet views to transform visual style attributes in the portlet rendering logic into markup language tags which can be rendered for display in a specified type of pervasive agent. To that end, the visual service extension can include a mapping of visual style attributes to markup language tags. As an example, in the markup

<styleTag: style stylebean=“bean”>
<p class=“myTextStyle”>My Text</p>
</styleTag:style>

the style bean, “bean” can gain control just after compilation from which device specific markup can be produced according to a dynamic style definition.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a schematic illustration of a portal server system which has been configured to render portlet content for display in pervasive agents; and,

FIG. 2 is a flow chart illustrating a process for rendering portlet content for display in pervasive agents.

### DETAILED DESCRIPTION OF THE PREFERRED EMBODIMENTS

The present invention is a system, method and apparatus for rendering a portal view in conformance with a specified style for display in one or more pervasive agents. In accordance with the present invention, the rendering logic for individual portlets can access a visual service in a portal aggregator in the portal server. The visual service can load a style sheet for the portal and can map visual rendering attributes to specific types of pervasive agents according to associated formatting rules. Rendering logic for each portlet can utilize the mapping when producing a view for the portlet. In this way, content can be suitably and consistently rendered in the portal, despite the disparate nature of target pervasive agents, without requiring a sacrifice in portal scalability and manageability.

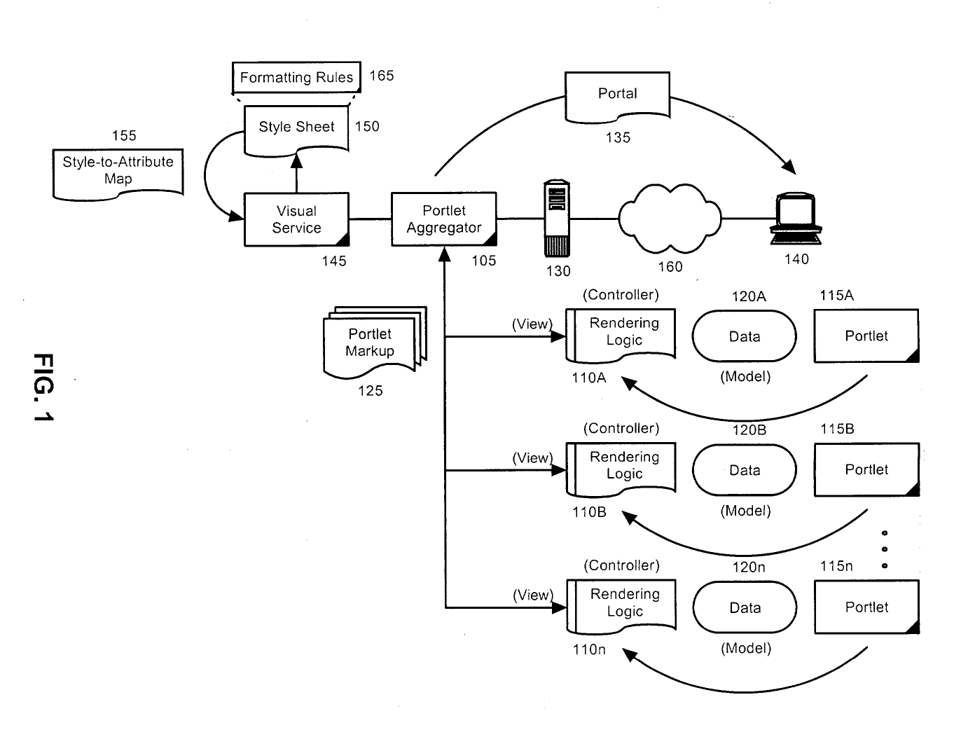

FIG. 1 is a schematic illustration of a portal server system which has been configured to render portlet content for display in pervasive agents. The portal server system can include a portal 135 communicatively coupled to a selection of portlets 115A, 115B, 115n through a portal server 130. Each portlet 115A, 115B, 115n can produce a view based upon portlet data 120A, 120B, 120n in the form of portlet markup 125 through corresponding rendering logic 110A, 110B, 110n. Notably, the rendering logic 110A, 110B, 110n can be active markup such as a JSP, in which logical scriptlets can be embedded to produce specific markup language tags.

A portlet aggregator 105 can be coupled to each portlet 115A, 115B, 115n to receive the portlet markup 125 and to aggregate the portlet markup into view in the portal 135. In this regard, the portal 135 can be disposed in the server 130 from which the portal 135 can be accessed by client devices 140 over a computer communications network 160 such as local computer communications network, for instance an intranet, or a global computer communications network, for instance the Internet. Notably, the client devices 140 can include both conventionally configured display resources, and pervasive devices having limited display resources.

In accordance with the present invention, a programmatic styling service, referred to herein as a visual service 145 can be coupled to the portlet aggregator 105 and can be accessed by individual ones of the rendering logic 110A, 110B, 100n. More particularly, the portlet aggregator 105 can be extended to insert the visual service 145, for instance a style bean or style sheet object, into the portal request object, such as an HttpSession or HttpRequest object where no session already exists. (Where a style sheet object has been inserted in lieu of a style bean, the rendering logic 110A, 10B, 110C can create a style bean based upon the style sheet object) Consequently, the rendering logic 110A, 110B, 110n of the portlets 115A, 115B, 115n can access the visual service 145.

The visual service 145 can be further coupled to one or more style sheets 150 defining one or more visual themes for the portal 135. Upon loading a style sheet 150, the visual service 145 can determine the current styling attributes for the portal 135 and from this construct, an internal style-to-attribute mapping 155 can be produced. Notably, when parsing the style sheet 150, each class defined within the style sheet 150 can include attributes that may apply to multiple tags. As an example, the class definition “.mytext {background-color #EBEBEB; color: #666666; font-family: sans-serif; font-size: 12pt;}” can result in the generation of a <font> tag. While the color, font-family, and font-size elements of the definition map to attributes specified through the <font> tag, multiple tags still can use the background-color attribute.

To determine which attributes in a style sheet are to be used with particular markup tags, the style sheet 150 can be augmented with a formatting rules properties file 165. The formatting rules properties file 165 can include a set of rules defined, for instance through key-value pairs, for generating new output. The key can be the tag name in this example, and the value can be the style sheet attributes that are to be used in connection with the tag as well as any descendant tags to render. Once created, the formatting rules properties file 165 need not change often for a particular markup DTD.

Within the style-to-attribute mapping 155, the mapping between style sheet_attribute name and the markup attribute name take a form similar to

“style sheet_attribute_name=html_attribute name(s)”.

Accordingly, as an example, the mapping for the <font> tag could include

“font=font-family=face,color=color,font-size=size”

in which the font-family, color, and font-size elements are attributes that apply to the <font> tag. Also, when creating the attributes tags, the face element could include the attribute name for the value of the element font-family in the style sheet, the color element could include the attribute name for the value of the color element in the style sheet, and the size element could include the attribute name for the value of the font-size element in the style sheet.

It will be recognized by the skilled artisan that the formatting rules properties file 165 is not so limited to the foregoing example. Rather, other rules also can be defined according to the type of device in which the portal 135 is to be rendered. For instance, as another example, a rule in the formatting rules properties file 165 can identify how to handle a table row tag, e.g. “<td>.: td=background-color=bgcolor; descendants=font”. Consequently, it will be noted that a single tag such as “<td class=“myText”>” could be interpreted for non-CSS enabled devices as: <td bgcolor=#EBEBEB”><font face=“sans-serif” color=#666666” size=“2”>.

Thus, in order to handle different rules for different devices, the formatting rules properties file 165 can be searched first for a name suffixed with a substring of a specific user-agent. In this regard, suffixes that begin with “_&” can identify a substring of the user-agent. Spaces within the substring can be represented by an underscore. For instance, name_&Windows_CE.properties, can be used for any device that contains the phrase “Windows CE” within its user-agent field. If specific formatting rules for the specified user-agent cannot be identified within the formatting rules properties file 165, a search for a markup specific properties file can be performed. In consequence, the markup specific properties file can be suffixed by the markup name.

For example, name_HTML.properties can be used for any HTML device which did not have device properties defined for the specific user-agent. If neither definitions exist in the formatting rules properties file 165, then a properties definition without any suffix can be used, e.g. name.properties. Thus, if the formatting rules properties file 165 has been named “tag map”, the search order for the formatting rules can include:

1) tagmap_&useragentsubstring.properties

2) tagmap_markup.properties

3) tagmap.properties

As a result, a wide range of granularity can be provided for the formatting rules, from device specific, to markup specific, to portal wide. These rules can also instruct the portal on how to handle unsupported entities such as images and colors.

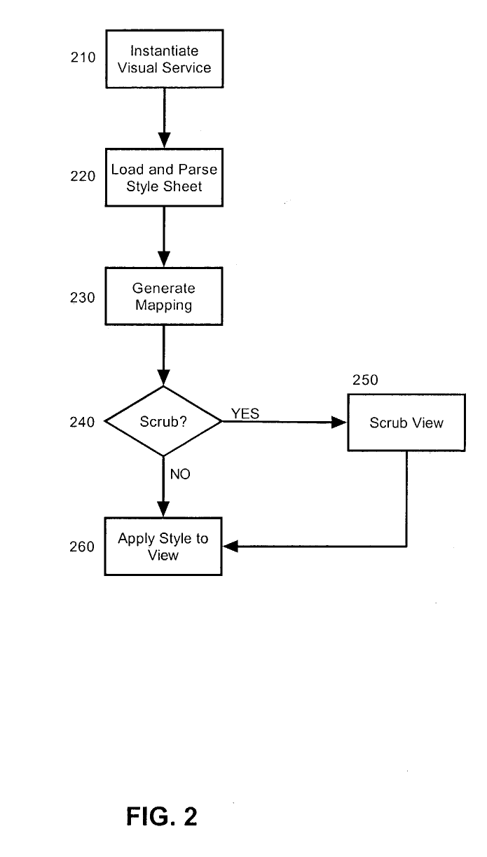

FIG. 2 is a flow chart illustrating a process for rendering portlet content for display in pervasive agents in the portal server system of FIG. 1. Beginning in block 210, an instance of the visual service can be created in association with the portlet aggregator. Specifically, an aggregation style object can be instantiated during the portlet aggregation stage of rendering a portal view. Once instantiated, the style object can be accessed by the rendering logic of the portlets through portlet request objects. In any event, in block 220, the portlet aggregator can load the portal theme style sheet to determine the current styling attributes for the portal. In block 230, from this construct, the aggregator can construct the style-to-attribute mapping.

For each portlet, the rendering logic, prior to compilation, can be modified with attributes and logic suitable for rendering the portlet view in a selected client such as a pervasive agent in accordance with the portal theme style sheet. Specifically, in decision block 240, it first can be determined whether to purge the rendering logic of references to unsupported visual elements. If so, in block 250, the contents of the rendering logic can be parsed, and any unsupported elements can either be changed to supported elements, or removed entirely.

For example, any inline styling tags can be removed from the rendering logic, such as a <b> or <i> tag. In this way, markup views, like HTML, can be supported though such views that have already been authored for a traditional browser. Moreover, the traditional markup views can be supported without requiring a developer to perform manual changes to the rendering logic. Finally, newly generated views can conform to a more styling restrictive markup language such as XHTML strict, for optimization purposes.

Finally, regardless of whether or not the rendering logic has been subjected to a scrub process in block 250, in block 260 the portal style abstraction can be applied to the view. In particular, a single tag within the rendering logic can be expanded into multiple tags such as in the above-reference table-row (<td>) example. It will be recognized by the skilled artisan that merely inlining the styling attributes of the portal style sheet into the rendering logic will not allow for dynamic style sheet theme selection. In particular, once the rendering logic has been parsed and modified, the rendering logic can be compiled into a servlet and cached on the server. As a result, any of the subsequent theme changes will not be applied to the cached servlet.

To account for both the expansion of multiple tags and for the dynamic style sheet theme selection, a style abstraction can be applied to the view recursively as follows in reference to the foregoing table row example. In that example, the JSP statement <tr class=“myText”> can be replaced with the scriptlet <%=styleBean.tag(“tr”, “myText”) %> in order to leverage the style bean aggregation service. This abstraction allows for dynamic decisions once the JSP has been compiled into a servlet.

In any case, all tags and class attributes can be found and replaced with the aforementioned scriptlet. Once the JSP has been compiled, the style bean performs the following recursive three-stage process in order to maintain dynamic styling ability. More particularly, the three-stage process can include first inserting an initial markup tag fragment in place of the scriptlet call. Second, tag attributes can be appended to the inserted fragment as specified by the style map. Finally, style descendants can be spawned to complete the inserted tag.

As an example, first, the scriptlet call can be replaced with the beginning of the markup tag. In the “myText” example, the markup tag fragment “<tr” can be inserted. Subsequently, attributes can be added to the current markup tag as defined in the style map with values from the current style sheet class name. Once again, in the “mytext” example, the markup tag fragment “bgcolor=‘EBEBEB’>” can be inserted. Finally, the next style descendants can be determined as defined by the style map. Each of the foregoing steps can be reprocessed recursively for the next style descendants until all descendants have been exhausted.

For instance, in the “mytext” example, the next tag fragment to append to the inserted tag fragment can include “font”. Thus, repeating the three-stage process for the “font” style descendant would result in “<tr bgcolor=‘EBEBEB’><font face=‘sans-serif’ color=‘#666666’ size=‘2’>”. This type of recursive algorithm would allow for a generic solution so that we can plug in new markup types, e.g. CHTML, without making changes to or having specialized code inside the style bean implementation.

In summary, for most pervasive devices, style sheet rendering is not supported. Yet, portal technology widely incorporates style sheet rendering as a matter of course in order to provide a consistent visual appearance between applications. This leads to inconsistent rendering of portal content for pervasive devices. By applying the style bean rendering technology of the present invention, the contents of a JSP dynamically can be changed such that styling tags can be generated which are compatible with a selected pervasive device while remaining true to the style setting of the portal. Consequently, through the use of the present invention, portal developers can write portlet code merely once for a conventional client, while having the code generate a proper portal appearance in pervasive devices.

The present invention can be realized in hardware, software, or a combination of hardware and software. An implementation of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A method for rendering a portal view in conformity with a portal style for display in a pervasive agent, the method comprising the steps of:
loading a style sheet defining a theme for the portal;
mapping visual rendering attributes for said defined theme to markup language tags specific to a specific type of pervasive agent;
parsing portlet rendering logic for a specified portlet to identify embedded style attribute references;
replacing selected ones of said embedded style attribute references in said portlet rendering logic with mapped ones of said markup language tags; and,
compiling said portlet rendering logic for use in producing a view for said specified portlet.

2. The method of claim 1, further comprising the step of purging said portlet rendering logic of unsupported tags.

3. The method of claim 2, wherein said purging step comprises the step of replacing said unsupported tags with supported tags.

4. The method of claim 2, wherein said purging step comprises the step of deleting said unsupported tags.

5. The method of claim 1, wherein said loading step comprises the steps of:
identifying one of a user agent for said portlet and a markup language type for said portlet; and,
loading a style sheet corresponding to said identified one of said user agent and said markup language type.

6. The method of claim 1, wherein said replacing step further comprises the step of replacing selected ones of said style attribute references in said portlet rendering logic with a scriptlet configured to recursively resolve a composite tag from a series of nested style attribute references according to mapped ones of said visual rendering attributes.

7. A portal server system comprising:
a portal coupled to a plurality of portlets, each of said portlets having associated portlet rendering logic;
a portlet aggregator communicatively linked to said portlet rendering logic; and,
a visual service extension to said portlet aggregator programmed to process said portlet rendering logic to transform visual style attributes in said portlet rendering logic into markup language tags which can be rendered for display in a specified type of pervasive agent.

8. The portal server system of claim 7, wherein said portlet rendering logic is a Java server page (JSP).

9. The portal server system of claim 7, wherein said visual service extension comprises a mapping of visual style attributes to markup language tags.

10. The portal server system of claim 7, further comprising a set of formatting rules selectably specifying said mapping for a particular characteristic of said pervasive agents.

11. The portal server system of claim 10, wherein said particular characteristic is a characteristic selected from the group consisting of user agent and markup language type.

12. A portal server comprising:
a portlet aggregator configured to aggregate portlet views into a single portal view; and,
a visual service extension to said portlet aggregator programmed to process portlet rendering logic for selected ones of said portlet views to transform visual style attributes in said portlet rendering logic into markup language tags which can be rendered for display in a specified type of pervasive agent.

13. The portal server of claim 12, wherein said portlet rendering logic is a Java server page (JSP).

14. The portal server of claim 12, wherein said visual service extension comprises a mapping of visual style attributes to markup language tags.

15 A machine readable storage having stored thereon a computer program for rendering a portal view in conformity with a portal style for display in a pervasive agent, the computer program comprising a routine set of instructions for causing the machine to perform the steps of:
loading a style sheet defining a theme for the portal;
mapping visual rendering attributes for said defined theme to markup language tags specific to a specific type of pervasive agent;
parsing portlet rendering logic for a specified portlet to identify embedded style attribute references;
replacing selected ones of said embedded style attribute references in said portlet rendering logic with mapped ones of said markup language tags; and,
compiling said portlet rendering logic for use in producing a view for said specified portlet.

16. The machine readable storage of claim 15, further comprising the step of purging said portlet rendering logic of unsupported tags.

17. The machine readable storage of claim 16, wherein said purging step comprises the step of replacing said unsupported tags with supported tags.

18. The machine readable storage of claim 16, wherein said purging step comprises the step of deleting said unsupported tags.

19. The machine readable storage of claim 15, wherein said loading step comprises the steps of:
identifying one of a user agent for said portlet and a markup language type for said portlet; and,
loading a style sheet corresponding to said identified one of said user agent and said markup language type.

20. The machine readable storage of claim 15, wherein said replacing step further comprises the step of replacing selected ones of said style attribute references in said portlet rendering logic with a scriptlet configured to recursively resolve a composite tag from a series of nested style attribute references according to mapped ones of said visual rendering attributes.
